(19) United States
(12) Patent Application Publication
(10) Pub. No.: US 2020/0043117 A1
(43) Pub. Date: Feb. 6, 2020

(54) PERSONAL THREAT AWARENESS SYSTEM

(71) Applicant: International Business Machines Corporation, Armonk, NY (US)

(72) Inventors: Daniela Kern Mainieri Trevisan, Porto Alegre (BR); Marcos Vinicius L. Paraiso, Campinas (BR); Luiz Gustavo Nascimento, Campinas (BR); Edinar Lopes de Aquino Junior, Hortolandia (BR)

(21) Appl. No.: 16/050,372

(22) Filed: Jul. 31, 2018

(51) Int. Cl. G06Q 50/26; G06F 17/30; H04W 4/029

(52) U.S. Cl. CPC G06Q 50/265; H04W 4/029; G06F 17/30241

(57) ABSTRACT

A method and system for determining a potential for a personal threat to a user based on location. A system receives geolocation data associated with the user, searches for information related to the geolocation data associated with the user, analyzes and correlates the information related to the geolocation data associated with the user and a location to calculate a level of risk to the user by evaluating dangerous situations which are currently in progress in or around the location; and when the level of risk to the user is imminent or latent, sending a personal notification describing the threat to the user.

### BACKGROUND

The present invention relates to a threat awareness system, and more specifically to a personal threat awareness system based on geolocation.

There are several unexpected and dangerous situations an individual or group of individuals can come across; The dangerous situations can be based on a natural disaster, such as, but not limited to: a thunderstorm, a tornado, a hurricane, a flood, a wildfire, an earthquake etc. The threat to an individual or group of individuals can also be from another person or group.

Dangerous situations can manifest based on location. An individual may be walking home after work without knowing that there path to their location may include a natural or unnatural threat, or they might be travelling to a remote location where a sudden shift in the weather has resulted in a tornado and is thus a dangerous situation.

In summary, there are innumerous threatening situations that can occur and an individual not being aware of them, drastically increases the risk level to an individual.

Even though there is a huge amount of data available to individuals from many sources about general warnings, this information needs to be correlated and analyzed to generate warnings/alerts which are specifically valuable to individuals. Today, if an individual is traveling to a bank for example and there is a robbery going on, the individual does not find out until they arrive to the bank. It would be much more efficient for an individual to be alerted of a critical situation before finding themselves in the dangerous situation.

### SUMMARY

According to one embodiment of the present invention a method of determining a potential for a personal threat to a user based on location is disclosed. The method comprising the steps of: receiving geolocation data associated with the user; searching for information related to the geolocation data associated with the user; analyzing and correlating the information related to the geolocation data associated with the user and a location to calculate a level of risk to the user by evaluating dangerous situations which are currently in progress in or around the location; and when the level of risk to the user is imminent or latent, sending a personal notification describing the threat to the user.

According to another embodiment of the present invention a computer program product for determining a potential for a person threat to a user based on location using a computer is disclosed. The computer comprising at least one processor, one or more memories, one or more computer readable storage media, the computer program product comprising a computer readable storage medium having program instructions embodied therewith. The program instructions executable by the computer to perform a method comprising: receiving, by the computer, geolocation data associated with the user; searching, by the computer, for information related to the geolocation data associated with the user; analyzing and correlating, by the computer, the information related to the geolocation data associated with the user and a location to calculate a level of risk to the user by evaluating dangerous situations which are currently in progress in or around the location; and when the level of risk to the user is imminent or latent, sending a personal notification describing the threat to the user.

According to another embodiment of the present invention a computer system for determining a potential for a person threat to a user based on location comprising a computer is disclosed. The computer system comprising at least one processor, one or more memories, one or more computer readable storage media having program instructions executable by the computer to perform the program instructions comprising: receiving, by the computer, geolocation data associated with the user; searching, by the computer, for information related to the geolocation data associated with the user; analyzing and correlating, by the computer, the information related to the geolocation data associated with the user and a location to calculate a level of risk to the user by evaluating dangerous situations which are currently in progress in or around the location; and when the level of risk to the user is imminent or latent, sending a personal notification describing the threat to the user.

### BRIEF DESCRIPTION OF THE DRAWINGS

FIG. 1 depicts a cloud computing node according to an embodiment of the present invention.

FIG. 2 depicts an abstraction model layers according to an embodiment of the present invention.

FIG. 3 shows a schematic of an example of the personal threat awareness system providing an alternate route to a user or group of users to avoid a dangerous situation.

FIG. 4 shows a schematic of the personal threat awareness system.

FIG. 5 shows a flowchart of a method of assessing and notifying at least one user of latent and imminent danger situations based on geolocation of the at least one user.

FIG. 6 shows internal components of computing devices and/or computing nodes in which illustrative embodiments may be implemented.

### DETAILED DESCRIPTION

In an embodiment of the present invention, a personal threat awareness system is implemented through cloud computing. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

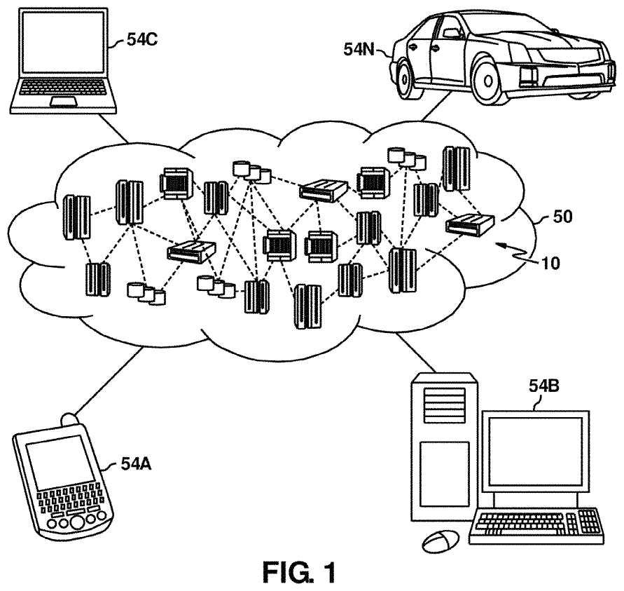

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone MA, desktop computer MB, laptop computer MC, and/or automobile computer system MN may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

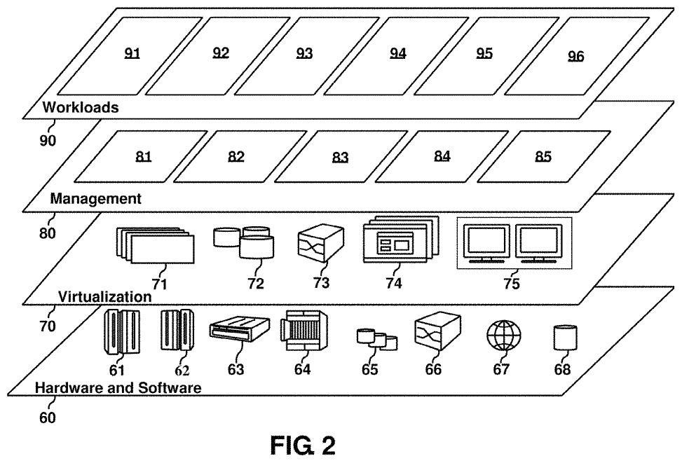

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and personal threat awareness system 96.

In an embodiment of the present invention, the personal threat awareness system aids a user in avoiding dangerous scenarios or situations through an autonomous method to continuously assess threats surrounding the user. The assessment can be based on, for example, consolidated information from devices such as mobile devices and smart sensors with geo-positioning tracking, as well as information derived from sensors in “Internet of Things” (IoT) devices. The method bases the assessment on information from these devices which are in a defined proximity to the user's location, and gathers as many threat signals as available from the devices which might be relevant to the user and their surroundings. The devices may be, but are not limited to, any device with a smart sensor, mobile devices, vehicles, etc.

The personal threat awareness system uses a centralized, cloud based system to constantly evaluate threats to the user. The personal threat awareness system monitors data from available sources to determine potential dangerous situations from natural and/or human originated threats, and correlates the data provided by the user's mobile device and any IoT wearable devices carried by the user with monitored data from the sources to determine or calculate if these dangerous situations pose a threat to the user's security. A destination, as set by a user via the user's mobile device can also set the location for determine whether potential dangerous situations are present from natural and/or human originated threats. The system can then provide alternative paths to a destination, or otherwise warn the user to avoid the threat from the dangerous situations.

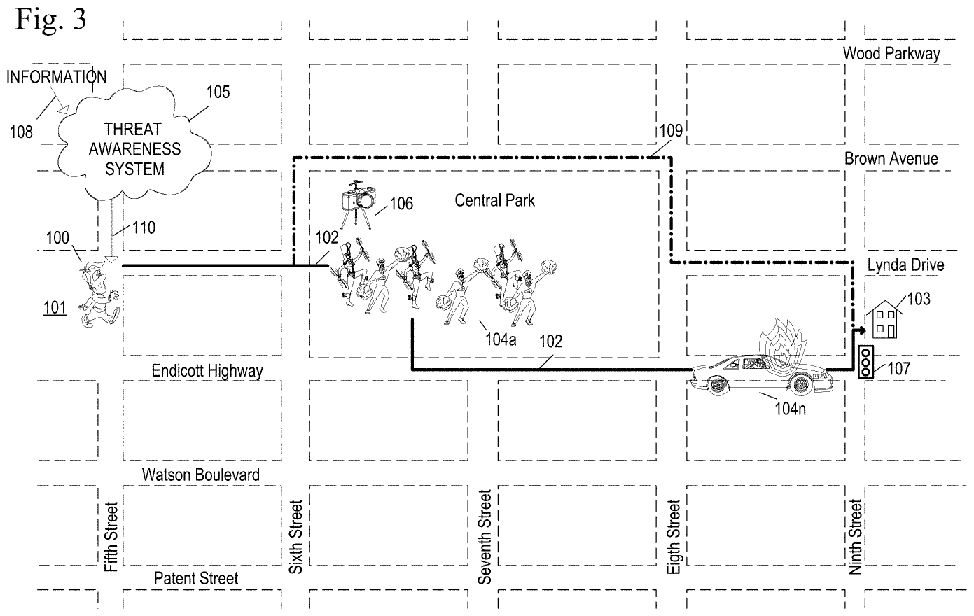

Referring to FIG. 3, a user 100 is traveling on a first, original path 102 from a location 101 to a destination 103. It should be noted that the method of the present invention can be executed for a single user, as shown in the figure, or for multiple users traveling to multiple destinations.

The original path 102 of the user 100 was the most direct, passing along Lynda Drive and cutting through Central Park to Endicott Highway, then turning left onto Ninth Street to the destination 103. A personal threat awareness system 105 receives data from devices present along the first, original path 102 through, for example, sensors in IoT devices, shown as a traffic light 107, and from publicly available security/surveillance monitoring systems, shown as camera 106, as well as other sensors in fixed and mobile positions.

Geo positioning systems like the Waze® Application for smart phones or tablets, or Google Maps® or Apple Maps, MotionX®, and others can be used for geolocation or to supplemental geo location data and a destination in which the user is traveling to may be determined from data from the geo positioning systems. Integrating geo positioning systems with the threat awareness system 105 enables risk identification and mitigation.

For example, the geo positioning system may be alerted that there is a critical situation on the selected path and to mitigate that, propose an alternate path; A user may also have the capability of setting its geo positing system to avoid dangerous neighborhoods when defining a path;

Additionally, the personal threat awareness system 105 receives information 108 from social networks, news feeds, other mobile devices, online information, criminal history, weather, data, etc.

Based on analysis of the data received by the personal threat awareness system 105 and on the location of the users 100, the personal threat awareness system 105 generates situation reports and predictive threat 110 alerts for the users 100. The threat alerts 110 include a broad range of risks such as dangerous locations based on past criminal activity, natural catastrophes and other threats to user 100.

In the example of FIG. 3, the threat awareness system 105 receives information 108 derived from the camera 106 in Central Park that there is a large rally 104a being held in the park, which could pose a threat of violence or pickpockets to user 100. In addition, traffic sensors in IoT device 107, the traffic light at the intersection of Endicott Highway and Ninth Street, provide information 108 about a car on fire 104n which is blocking Endicott Highway between Eighth and Ninth Streets.

Based on this information 108, and other information derived from, for example, location data from a large number of cell phones held by people at the rally 104a, or data regarding the car fire 104n from emergency services authorities or posts by users of social media such as the Waze App, the threat awareness system 105 issues a predictive threat alert 110 for user 100, advising the user that their original path 102 will lead through multiple threats 104a and 104n. The geolocation system in user 100's smartphone accepts the predictive threat alert 110 and suggests an alternate path 109, taking Sixth Street to Brown Avenue, then south on Eight Street to Lynda Drive and south on Ninth Street to the destination 103.

It should be noted that the predictive threat alerts 110 are not general alerts, but are alerts which are tailored to each of the users based on their preferences, their current location, their destination, and/or the route they travel between the current location and their destination.

Individual users may view risk differently. For instance, a user may live in a dangerous neighborhood, but they understand this latent risk is acceptable and do not need alerts about that. However, the user may want to be notified about imminent risks if a dangerous situation is in progress. For example, and referring to FIG. 3 above, if the user had removed a related event such as pickpocketing or a threat of violence from defining the level of risk associated with an imminent risk, the user would not receive a predictive threat alert.

Users can perform a personalized classification of risks per their risks, and this classification can be used by the threat awareness system 105 in deciding what predictive threat alerts 110 to issue to individual users. In the example of FIG. 3, the rally 104a might be harmless in itself, say a pep rally for the local Junior High School, such that an alert 110 would not normally be issued, but user 100 might have set a preference in the threat awareness system 105 which indicates that he does not like crowds, so the awareness system 105 would still consider the rally 104a a “threat” as applied to this particular user 100

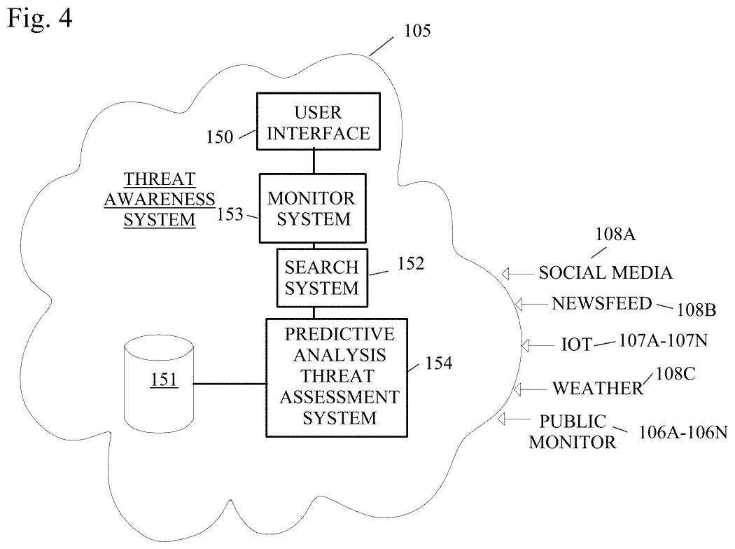

FIG. 4 shows a schematic of the personal threat awareness system 105. The personal threat awareness system is cloud based. The personal threat awareness system 105 includes a user interface 150. The user interface 150 can accept commands regarding at least personal threats, destination, threat levels for the individual user, notifications and selection of an alternate route to avoid a threat and/or dangerous situation.

A threat database 151 includes, but is not limited to, a user's personal definitions of what defines a threat, levels of threat, types of threats, frequent locations visited by the user, registered IoT devices of a user, geo-positional information related to the user and other information. The levels of threat are predefined into risk levels of latent and imminent and associated related events defining each of the risk levels. For example, a latent risk level has, for example, predefined related events of dangerous regions or neighborhoods with a high crime rate. In another example, the imminent level of risk has, predefined related events of natural disaster, current crime activity, conflict zone of a country. The user can remove, revise and/or alter the related events associated with each of the risk levels. For example, the user can alter which dangerous regions are associated with the latent risk level if the user has to regularly pass through such a neighborhood or lives in such a neighborhood. If the related event is not defined or assigned to either the risk levels of latent or imminent, the event is considered a non-risk or not a threat.

The personal threat awareness system 105 also includes a search or crawl system 152 which searches for data input for information related to a user's geo location. The search system 152 searches data such as social media, news feeds, publicly available information regarding geo locations 106a-106n, weather and any other information regarding a location and possible threats.

A monitoring system 153 monitors for geo location data of the user and their associated route to their destination.

A predictive analysis threat assessment system 154 analyzes and correlates the threats of a user in and to a specific geo location. The predictive analysis threat assessment system 154 can preferably include a notifications system to notify the user of an imminent threat, latent threat or level of threat present in their approximate geo location, along the route to a user destination or within a range of the geo location of the user. Alternatively, a separate system may be used to send out the notifications.

An imminent threat is a threat which is immediate and would possible result in death or serious physical harm could occur within a short time. The imminent threat may be currently occurring in real time. A latent threat is a threat which is potential, but not obvious or explicit; Latent threats are calculated based on frequency of events in the location. An example of an imminent threat is a tropical storm hitting a location. Headlines on the news or posts in social media may include information regarding the location in which the tropical storm is currently occurring. A latent threat may be the flooding that will occur due to the current imminent threat of the tropical storm. Another example of a latent threat is a weather watch for a tornado.

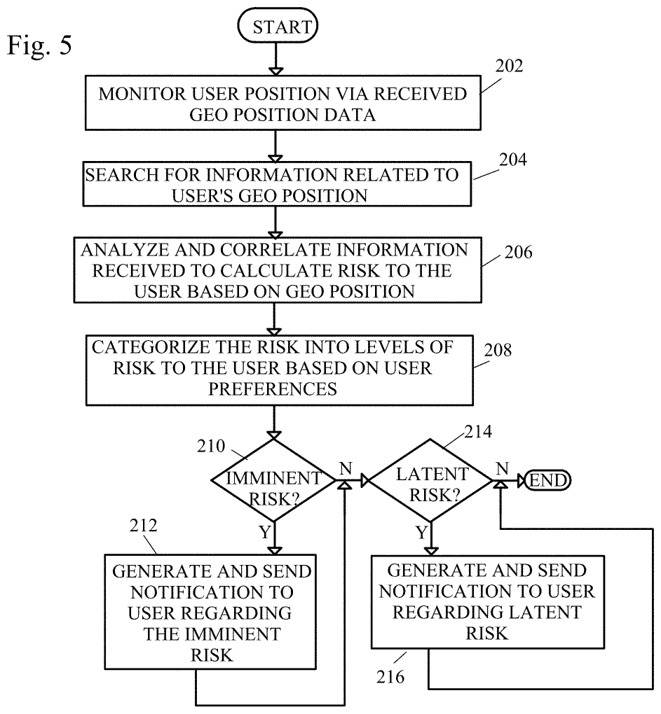

FIG. 5 shows a flow diagram of a method of assessing and notifying at least one user of latent and imminent danger situations based on geolocation of the at least one user.

It should be noted that prior to the method of FIG. 5, a user would register their IoT devices, frequent destinations, their personal threat levels, and preferences regarding notifications. These preferences can be updated at any time.

In a first step, the personal threat awareness system monitors a user's position through geo position data (step 202). The geo position data of a user may be monitored through a user's mobile device or any other location aware device. A location aware device is a device which that can passively or actively determine their location.

The personal threat awareness system searches for information related to a user's geo position (step 204). The information may include, but is not limited to surveillance camera data, criminal databases, weather data, public data, and other sources of data. The surveillance camera data can include data that may indicate dangerous situations which are currently occurring or have recently occurred, such as fight, bandit chase, a fire, etc. The criminal databases identify locations with a high number of criminal activity occurrences. Other sources of data may include, but is not limited to general information such as dangerous neighborhoods or streets, hours where there is more incidence of robberies, average of homicides for a specific location and time, etc.

Then the information is analyzed and correlated to calculate the levels of risk to the user based on the geo position and/or destination (step 206). In this step, all data gathered is correlated to evaluate the probability of threats and/or identify whether the threat is a risk level of imminent, latent or non-risk based on events which are currently in progress in or around the user's geo location or destination.

The risks identified are categorized into levels of risk to the user based on user preferences (step 208). The user preferences allow the user to define user delineations of risk.

If the level of risk is imminent (step 210), the personal threat awareness system generates and sends notification to the user regarding the imminent risk (step 212) and the method continues to step 214.

If the level of risk is not imminent (step 210), the method continues with step 214.

If the level of risk is latent (step 214), the personal threat awareness system generates and sends notification to the user regarding the latent risk (step 216) and the method ends.

If the level of risk is not latent (step 214), the level of risk is non-threat and the method ends.

As the user's position changes, steps 202-214 are repeated. In an alternate embodiment, the method may be implemented based on a destination of the user received by the threat awareness system 105. Therefore in step 204, the threat awareness system 105 would additionally search for information related to the destination entered by the user. Therefore, the user would receive any reports regarding imminent or latent threats prior to reaching the destination. If no threats are received or the threat is not a related event which defines a latent or imminent threat, the event is a non-threat and the user is not notified.

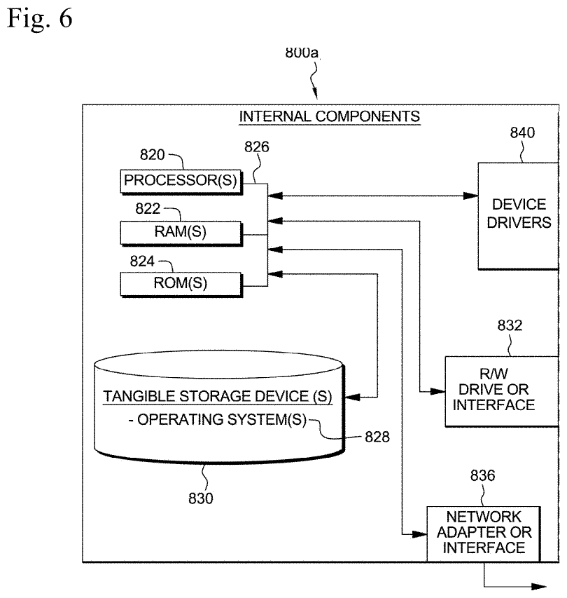

FIG. 6 illustrates internal components of computing devices 54A-N and/or computing nodes 10 in which illustrative embodiments may be implemented. In FIG. 6, computing devices 54A-N and/or computing nodes 10 include internal components 800a. Each of the sets of internal components 800a includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 are stored on one or more of the computer-readable tangible storage devices 830 for execution by one or more of the processors 820 via one or more of the RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a also includes a R/W drive or interface 832 to read from and write to one or more portable computer-readable tangible storage devices (not shown) such as a CD-ROM, DVD, memory stick, magnetic tape, magnetic disk, optical disk or semiconductor storage device.

Each set of internal components 800a also includes a network adapter or interface 836 such as a TCP/IP adapter card as well as a device drivers to interface with other accessories.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of determining a potential for a personal threat to a user based on location comprising the steps of:
receiving geolocation data associated with the user;
searching for information related to the geolocation data associated with the user;
analyzing and correlating the information related to the geolocation data associated with the user and a location to calculate a level of risk to the user by evaluating dangerous situations which are currently in progress in or around the location; and
when the level of risk to the user is imminent or latent, sending a personal notification describing the threat to the user.

2. The method of claim 1, wherein the location is based on the geolocation data.

3. The method of claim 1, wherein the location is the destination of the user.

4. The method of claim 1, wherein the geolocation data is received from a location-aware device associated with the user.

5. The method of claim 1, wherein in the step of searching for information related to the geolocation data associated with the user further comprises searching for information regarding a destination of the user received from the user.

6. The method of claim 1, wherein the information related to geolocation data consists of surveillance camera data, criminal databases, public databases, and weather data.

7. The method of claim 1, wherein the level of risk to the user is further based on user definitions of personal risk.

8. A computer program product for determining a potential for a person threat to a user based on location using a computer comprising at least one processor, one or more memories, one or more computer readable storage media, the computer program product comprising a computer readable storage medium having program instructions embodied therewith, the program instructions executable by the computer to perform a method comprising:
receiving, by the computer, geolocation data associated with the user;
searching, by the computer, for information related to the geolocation data associated with the user;
analyzing and correlating, by the computer, the information related to the geolocation data associated with the user and a location to calculate a level of risk to the user by evaluating dangerous situations which are currently in progress in or around the location; and
when the level of risk to the user is imminent or latent, sending a personal notification describing the threat to the user.

9. The computer program product of claim 8, wherein the location is based on the geolocation data.

10. The computer program product of claim 8, wherein the location is the destination of the user.

11. The computer program product of claim 8, wherein the geolocation data is received from a location-aware device associated with the user.

12. The computer program product of claim 8, wherein in the program instructions of searching, by the computer, for information related to the geolocation data associated with the user further comprises searching for information regarding a destination of the user received from the user.

13. The computer program product of claim 8, wherein the information related to geolocation data consists of surveillance camera data, criminal databases, public databases, and weather data.

14. The computer program product of claim 8, wherein the level of risk to the user is further based on user definitions of personal risk.

15. A computer system for determining a potential for a person threat to a user based on location comprising a computer comprising at least one processor, one or more memories, one or more computer readable storage media having program instructions executable by the computer to perform the program instructions comprising:
receiving, by the computer, geolocation data associated with the user;
searching, by the computer, for information related to the geolocation data associated with the user;
analyzing and correlating, by the computer, the information related to the geolocation data associated with the user and a location to calculate a level of risk to the user by evaluating dangerous situations which are currently in progress in or around the location; and
when the level of risk to the user is imminent or latent, sending a personal notification describing the threat to the user.

16. The computer system of claim 15, wherein the location is based on the geolocation data.

17. The computer system of claim 15, wherein the location is the destination of the user.

18. The computer system of claim 15, wherein in the program instructions of searching, by the computer, for information related to the geolocation data associated with the user further comprises searching for information regarding a destination of the user received from the user.

19. The computer system of claim 15, wherein the information related to geolocation data consists of surveillance camera data, criminal databases, public databases, and weather data.

20. The computer system of claim 15, wherein the level of risk to the user is further based on user definitions of personal risk.
